(19) United States
(12) Patent Application Publication
(10) Pub. No.: US 2026/0226784 A1
(43) Pub. Date: Aug. 6, 2026

(54) VEHICLE CONTROL APPARATUS

(71) Applicant: TOYOTA JIDOSHA KABUSHIKI KAISHA, Toyota-shi (JP)

(72) Inventor: Masahiro HARADA, Ebina-shi (JP)

(73) Assignee: TOYOTA JIDOSHA KABUSHIKI KAISHA, Toyota-shi (JP)

(21) Appl. No.: 19/424,695

(22) Filed: Dec. 18, 2025

(30) Foreign Application Priority Data
Feb. 6, 2025 (JP) 2025-018618

(51) Int. Cl. E05F 15/70; G07C 5/10; B60W 60/00

(52) U.S. Cl. CPC E05F 15/70; G07C 5/10; B60W 60/00; E05Y 2400/36; E05Y 2900/55

(57) ABSTRACT

A vehicle control device that automatically performs an opening and closing operation of a window of an autonomous driving vehicle includes a window state detection device that detects an opening and closing state of the window, an opening and closing device that opens and closes the window by driving an actuator, and a control device that controls an operation of the opening and closing device. The control device is configured to execute an opening and closing state acquisition process of acquiring an opening and closing state detected by a window state detection device, an operation pattern determination process of determining an operation pattern of an opening and closing operation based on the opening and closing state acquired in the opening and closing state acquisition process, and a drive process of driving an opening and closing device before the autonomous driving vehicle starts traveling by autonomous driving.

### CROSS-REFERENCE TO RELATED APPLICATION

This application claims priority to Japanese Patent Application No. 2025-018618 filed on February 6, 2025. The disclosure of the above-identified application, including the specification, drawings, and claims, is incorporated by reference herein in its entirety.

### BACKGROUND

### Technical Field

The present disclosure relates to a vehicle control apparatus, and more particularly, to a vehicle control apparatus that controls an opening and closing operation of a window of an autonomous driving vehicle.

### Description of Related Art

Japanese Unexamined Patent Application Publication No. 2018-138734 (JP 2018-138734 A) discloses a system that notifies an occupant seated on a vehicle seat of an operation of an opening and closing body when a window glass of a vehicle door is automatically opened and closed. The system operates the window glass through a motor body of a power window motor when a seating sensor of the vehicle seat is in an on state. In this case, a frequency in an audible range is included in a control frequency in PWM control to perform a sound generation operation by causing the motor body to vibrate in the audible range.

### SUMMARY

In the system of JP 2018-138734 A, a motor that can include the frequency in the audible range in the control frequency in PWM control is needed, and there is a problem of restricting a target component and complicating a system. Here, a risk when a window is automatically opened and closed is different depending on a situation such as an opening and closing state of the window. In a case where the risk according to the situation can be reflected in control of an opening and closing operation of the window, it is possible to close the window safely with a simpler configuration.

The present disclosure has been made in view of the above problems, and an object of the present disclosure is to provide a vehicle control apparatus capable of safely closing a window by an opening and closing operation according to a risk when the window is automatically opened and closed, before an autonomous driving vehicle starts traveling by autonomous driving.

In order to solve the above problems, the present disclosure provides a vehicle control apparatus configured to automatically perform an opening and closing operation of a window of an autonomous driving vehicle, the vehicle control apparatus including:

a window state detection device configured to detect an opening and closing state of the window;

an opening and closing device configured to open and close the window by driving an actuator; and

a control device configured to control an operation of the opening and closing device.

The control device is configured to, before the autonomous driving vehicle starts traveling by autonomous driving, execute:

an opening and closing state acquisition process of acquiring the opening and closing state detected by the window state detection device;

an operation pattern determination process of determining an operation pattern of the opening and closing operation based on the acquired opening and closing state in the opening and closing state acquisition process; and

a drive process of driving the opening and closing device in accordance with the determined operation pattern in the operation pattern determination process.

In addition, the vehicle control apparatus of the present disclosure may include a dust detection device configured to detect a dust amount floating around the autonomous driving vehicle.

The control device may be configured to, before the autonomous driving vehicle starts traveling by autonomous driving,

further execute a dust state acquisition process of acquiring the dust amount detected by the dust detection device, and in the operation pattern determination process, the control device may be configured to determine the operation pattern based on the acquired opening and closing state in the opening and closing state acquisition process and the acquired dust amount in the dust state acquisition process.

In addition, in the operation pattern determination process of the vehicle control apparatus of the present disclosure, the control device may be configured to determine, as the operation pattern:

a pattern in which, in a case where the acquired opening and closing state in the opening and closing state acquisition process is fully open, the window is operated to be closed by a predetermined amount, operated to be fully open again, and then operated to be fully closed;

a pattern in which, in a case where the acquired opening and closing state in the opening and closing state acquisition process indicates an opening degree between an intermediate opening degree that is predetermined and a fully closed opening degree, the window is operated to be fully closed without being operated in an opening direction; and

a pattern in which, in a case where the acquired opening and closing state in the opening and closing state acquisition process indicates an opening degree between the intermediate opening degree and the fully open opening degree, the window is operated to be fully open and then operated to be fully closed.

In addition, in the operation pattern determination process of the vehicle control apparatus of the present disclosure, the control device may be configured to determine, as the operation pattern, a pattern in which the window is fully closed without being operated toward an opening direction, in a case where the acquired dust amount in the dust state acquisition process is higher than a first determination threshold that is predetermined.

Further, in the operation pattern determination process of the vehicle control apparatus of the present disclosure, the control device may be configured to

set an operation speed of the opening and closing operation in the operation pattern to be higher in a case where the acquired dust amount in the dust state acquisition process is higher than a second determination threshold that is predetermined, as compared with a case where the dust amount is lower than the second determination threshold.

A risk that an event, such as a pinching, occurs when the window is automatically opened and closed is different depending on the opening and closing state of the window. With the vehicle control apparatus of the present disclosure, before the autonomous driving vehicle starts traveling by autonomous driving, the operation pattern of the opening and closing operation of the window is determined based on the opening and closing state. As a result, it is possible to safely close the window by the opening and closing operation according to the risk when the window is automatically opened and closed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a vehicle control device according to an embodiment of the present disclosure;

FIG. 2 is a diagram showing a functional block of the control device;

FIG. 3 is a flowchart of a routine showing a first example of processing executed by the vehicle control device of the present embodiment;

FIG. 4 is a flowchart of a routine showing a second example of the processing executed by the vehicle control device of the present embodiment;

FIG. 5 is a flowchart of a routine showing a third example of the processing executed by the vehicle control device of the present embodiment; and

FIG. 6 is a flowchart of a routine showing a fifth example of the processing executed by the vehicle control device of the present embodiment.

### DETAILED DESCRIPTION OF EMBODIMENTS

Hereinafter, an embodiment of the present disclosure will be described. Note that, in the embodiment shown below, when the number of elements, such as the number of elements, the amount, the quantity, and the range, is referred to, the present disclosure is not limited to the referred number unless otherwise specified or unless the referred number is clearly specified by principle. In addition, the structure, steps, and the like described in the embodiment shown below are not always needed for the present disclosure unless otherwise specified or unless the structure, steps, and the like are clearly specified by principle.

### EMBODIMENT

### Configuration of Vehicle Control Device of Embodiment

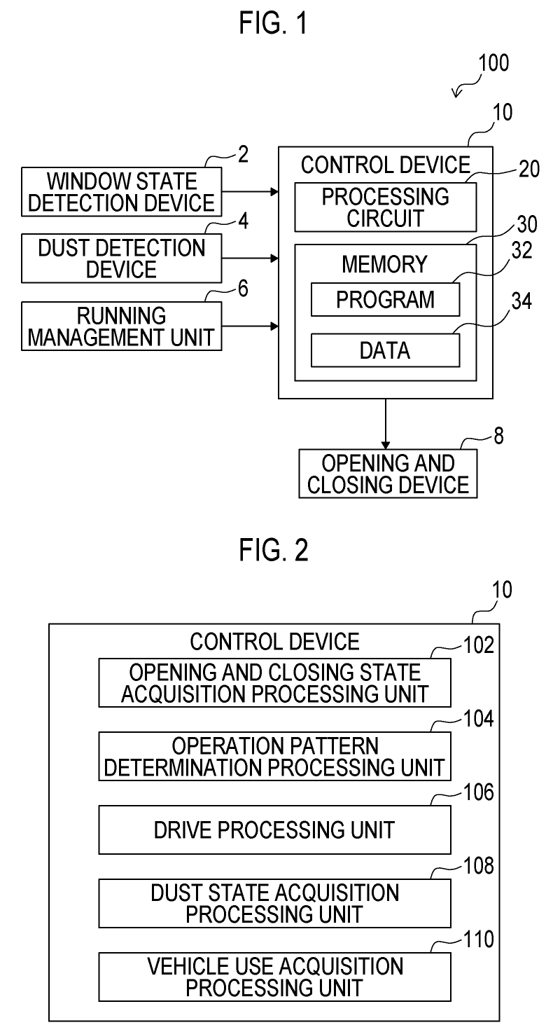

FIG. 1 is a diagram schematically showing a configuration of a vehicle control device according to the embodiment of the present disclosure. The vehicle control device 100 is mounted on an autonomous driving vehicle. The autonomous driving vehicle is capable of autonomous driving by a driverless. The power source of the autonomous driving vehicle is not limited. The autonomous driving vehicle is used as a people flow use that provides a vehicle allocation service to a pick-up position and a transportation service to a destination for a user. Alternatively, the autonomous driving vehicle is used as a logistics use that provides a transportation service of transporting goods to a destination. The configuration of the power system of the autonomous driving vehicle and the configuration of the control system for autonomous driving are already known in many documents, and thus the description thereof will be omitted here.

The autonomous driving vehicle includes a window (glass window) that is freely openable and closable. In a case where the autonomous driving vehicle starts traveling by autonomous driving, a situation in which the window is open is considered. Examples of such a situation include a situation in which the operator forgets to close the window after opening the window when the operator performs the work in the vehicle cabin, a situation in which the driver of the manual driving forgets to close the window that the driver has opened during driving and gets off the vehicle to switch to the autonomous driving, and a situation in which the user mistakenly opens the window before switching to the autonomous driving. In such a situation, in a case where the autonomous driving vehicle automatically performs the opening and closing operation of the window, it is preferable that the window is quickly fully closed when the risk of the occurrence of the event in which the user is pinched in the gap of the window is low. On the other hand, depending on the risk of the occurrence of the event in which the user is pinched in the gap of the window, it is sometimes preferable to accompany the opening and closing operation with an auxiliary opening and closing operation that attracts the attention of the person. The vehicle control device 100 of the present disclosure is a device for executing control to automatically and safely close an open window by an opening and closing operation according to a risk before the autonomous driving vehicle starts traveling by autonomous driving.

The vehicle control device 100 includes a window state detection device 2, a dust detection device 4, a running management unit 6, an opening and closing device 8, and a control device 10.

The window state detection device 2 is a device for detecting the opening and closing state of the window of the autonomous driving vehicle. The window state detection device 2 is, for example, an opening degree sensor that detects an opening degree of the window between 0% (fully closed) and 100% (fully open) as the opening and closing state of the window. In a case where the autonomous driving vehicle includes a plurality of windows that is freely openable and closable, the window state detection device 2 is configured to detect the opening and closing state of each window.

The dust detection device 4 is a device for detecting a dust amount floating in the surrounding environment of the autonomous driving vehicle. The dust detection device 4 is, for example, a dust sensor that outputs a signal according to the amount of dust particles floating in space as the dust amount of the dust. The detection method of the dust sensor can adopt a known detection method, such as an infrared method or a laser method.

The running management unit 6 is a part of the function of the autonomous driving system of the autonomous driving vehicle. Typically, the running management unit 6 is a functional block for managing whether the autonomous driving performed by the autonomous driving vehicle is a people flow use related to the transportation of a person or a logistics use related to the transportation of an object.

The opening and closing device 8 is a drive device for performing the opening and closing operation of the window of the autonomous driving vehicle by driving the actuator. The actuator is, for example, a power window motor. In a case where the autonomous driving vehicle includes a plurality of windows that is freely openable and closable, the opening and closing device 8 includes a plurality of actuators corresponding to the respective windows.

The control device 10 is typically an electronic control unit (ECU). The switch and the equipment to be controlled mounted on the autonomous driving vehicle are connected to the control device 10 by an in-vehicle network, such as a controller area network (CAN). The control device 10 may be a combination of a plurality of ECUs. The control device 10 includes at least a processing circuit 20 and a memory 30. The memory 30 includes a RAM for temporarily recording data and a ROM for storing a program 32 and various data 34 related to the program that can be executed by the processing circuit 20. The program 32 is configured of a plurality of instructions. The processing circuit 20 reads and executes the program 32 and the data 34 from the memory 30, and generates the control signal based on the signal acquired from each sensor.

The processing circuit 20 may be implemented to include at least one of a general-purpose processor, a specific-purpose processor, an integrated circuit, application specific integrated circuits (ASICs), a central processing unit (CPU), a circuit in the related art, and a combination thereof. The processing circuit 20 is hardware programmed to implement the functions described below or hardware that executes the functions described below. The processing circuit 20 may include any hardware that is programmed to implement the function described below or that executes the function described below.

FIG. 2 is a diagram showing a functional block of the control device. The control device 10 includes an opening and closing state acquisition processing unit 102, an operation pattern determination processing unit 104, a drive processing unit 106, a dust state acquisition processing unit 108, and a vehicle use acquisition processing unit 110 as functional blocks for performing the opening and closing operation of the window. Hereinafter, processing executed in each of the functional blocks will be described in detail. The dust state acquisition processing unit 108 and the vehicle use acquisition processing unit 110 are not always needed as a configuration of the control device 10, but are selectively needed as a configuration in the opening and closing operation of the window using the dust state acquisition processing unit 108 and the vehicle use acquisition processing unit 110.

### Function of Vehicle Control Device of Embodiment

### Opening and Closing State Acquisition Processing Unit 102

The opening and closing state acquisition processing unit 102 is a functional block for executing processing of acquiring the opening and closing state of the window of the autonomous driving vehicle. The process is referred to as an “opening and closing state acquisition process” hereinafter. Typically, in the opening and closing state acquisition process, the opening and closing state acquisition processing unit 102 acquires an opening degree (%) of the window based on a detection signal output from the window state detection device 2. The opening degree acquired by the opening and closing state acquisition process is transmitted to the operation pattern determination processing unit 104.

### Operation Pattern Determination Processing Unit 104

The operation pattern determination processing unit 104 is a functional block for executing processing of determining an operation pattern of the opening and closing operation of the window. The process is referred to as an “operation pattern determination process” hereinafter. The data 34 of the memory 30 stores a plurality of operation patterns that is predetermined. In the operation pattern determination process, the operation pattern determination processing unit 104 decides which operation pattern to execute from among the predetermined operation patterns based on the opening degree acquired by the opening and closing state acquisition process.

Alternatively, in the operation pattern determination process, the operation pattern determination processing unit 104 decides which operation pattern to execute from among the predetermined operation patterns based on the opening degree acquired by the opening and closing state acquisition process and the dust amount acquired by a dust state acquisition process described later.

Alternatively, in the operation pattern determination process, the operation pattern determination processing unit 104 decides which operation pattern to execute from among the predetermined operation patterns based on the opening degree acquired by the opening and closing state acquisition process and the vehicle use information acquired by a vehicle use acquisition process described later.

The operation patterns include a first operation pattern, a second operation pattern, and a third operation pattern. The first operation pattern is an operation pattern in which the window is operated to a fully closed state in a closing direction without being operated in an opening direction. The second operation pattern is an operation pattern in which the window is operated by a predetermined operation amount in the closing direction, then the window is operated to a fully open state in the opening direction, and then the window is operated to a fully closed state in the closing direction. The predetermined amount is a value determined in advance as an operation amount for making the user aware that the opening and closing operation of the window is automatically performed. The third operation pattern is an operation pattern in which the window is operated to a fully open state in the opening direction once, and then the window is operated to a fully closed state in the closing direction. The operation pattern determined by the operation pattern determination process is transmitted to the drive processing unit 106.

In the operation pattern determination process, the operation pattern determination processing unit 104 may be configured to set the operation speed of the opening and closing device 8 for each operation pattern.

### Drive Processing Unit 106

The drive processing unit 106 is a functional block for executing processing of driving the opening and closing device 8 in accordance with the operation pattern determined by the operation pattern determination processing. The process is referred to as “drive processing” hereinafter.

### Dust State Acquisition Processing Unit 108

The dust state acquisition processing unit 108 is a functional block for executing processing of acquiring the amount of dust floating in the surrounding environment of the autonomous driving vehicle. The process is referred to as “dust state acquisition processing” hereinafter. Typically, in the dust state acquisition process, the dust state acquisition processing unit 108 acquires the dust amount based on the detection signal output from the dust detection device 4. The dust amount acquired by the dust state acquisition process is transmitted to the operation pattern determination processing unit 104.

### Vehicle Use Acquisition Processing Unit 110

The vehicle use acquisition processing unit 110 is a functional block for executing processing of acquiring the vehicle use of the autonomous driving performed by the autonomous driving vehicle. The process is referred to as “vehicle use acquisition processing” hereinafter. Typically, in the vehicle use acquisition process, the vehicle use acquisition processing unit 110 acquires the vehicle use information including the information indicating whether the vehicle use is the people flow use or the logistics use from the running management unit 6. The vehicle use information acquired by the vehicle use acquisition process is transmitted to the operation pattern determination processing unit 104.

### Specific Processing Executed by Vehicle Control Device in Embodiment

### First Example

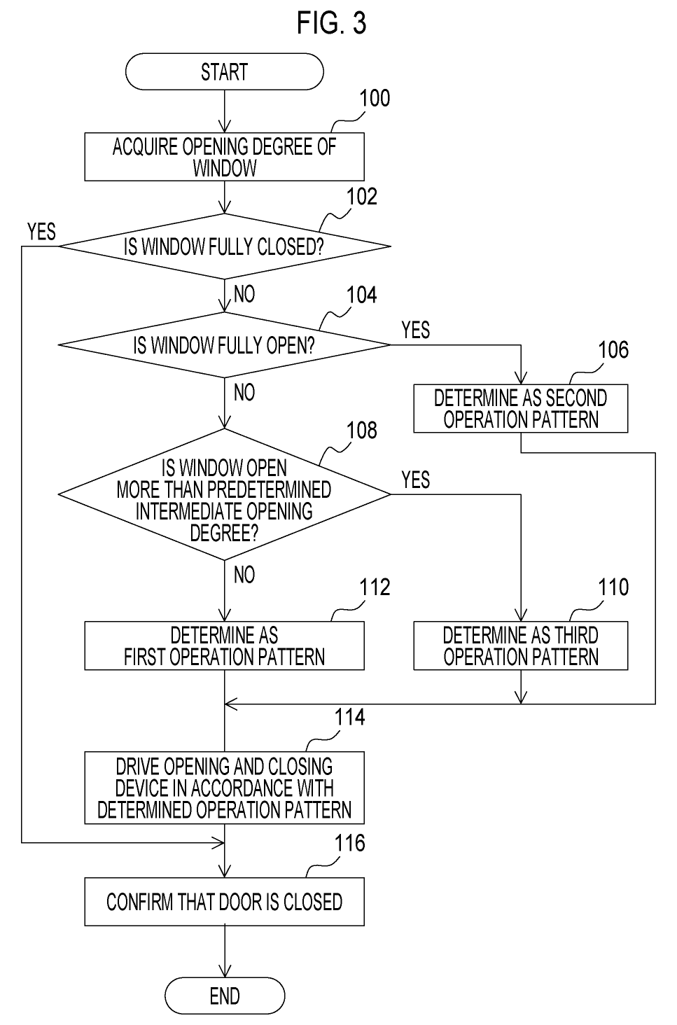

A first example of specific processing executed by the vehicle control device 100 of the present embodiment will be described. The first example is an example of processing of determining an operation pattern based on an opening degree of a window. FIG. 3 is a flowchart of a routine showing a first example of the processing executed by the vehicle control device of the present embodiment. The routine shown in FIG. 3 is executed by the control device 10 before the autonomous driving vehicle starts traveling by autonomous driving.

In step 100, the opening and closing state acquisition process is executed in the opening and closing state acquisition processing unit 102 to acquire the opening degree of the window. When the processing of step 100 is completed, the processing proceeds to step 102.

The processing of steps 102 to 112 is a part of the operation pattern determination process executed by the operation pattern determination processing unit 104. In step 102, the determination is made whether the window is fully closed based on the opening degree of the window acquired by the opening and closing state acquisition process. As a result, in a case where the determination is established, the window closing operation is determined to be unnecessary, and the processing proceeds to step 116. On the other hand, in a case where the determination in step 102 is not established, the processing proceeds to step 104.

In step 104, the determination is made whether the window is fully open based on the opening degree of the window acquired by the opening and closing state acquisition process. As a result, in a case where the determination is established, the processing proceeds to step 106. In step 106, the second operation pattern is decided as the operation pattern. When the processing of step 106 is completed, the processing proceeds to step 114.

On the other hand, in a case where the determination in step 104 is not established, the determination is made that the window is in an opening degree between the fully open state and the fully closed state, and the processing proceeds to step 108. In step 108, the determination is made whether the window is opened more than a predetermined intermediate opening degree based on the opening degree of the window acquired by the opening and closing state acquisition process. The intermediate opening degree is a predetermined opening degree (for example, 90%) as an opening degree at which a user’s arm does not enter the window opening portion. The intermediate opening degree is stored in the data 34 of the memory 30. Here, the intermediate opening degree is read from the memory 30, and it is determined whether the opening degree of the window acquired by the opening and closing state acquisition process is the opening degree between the intermediate opening degree and the fully open state. As a result, in a case where the determination is established, it is determined that there is a possibility that the user’s arm or the like is pinched when the window is suddenly operated in the closing direction, and the processing proceeds to step 110. In step 110, the third operation pattern is decided as the operation pattern. When the processing of step 110 is completed, the processing proceeds to step 114.

On the other hand, in a case where the determination in step 108 is not established, that is, in a case where the opening degree of the window is between the intermediate opening degree and the fully closed state, it is determined that there is no possibility that the user’s arm or the like is pinched even when the window is suddenly operated in the closing direction, and the processing proceeds to step 112. In step 112, the first operation pattern is decided as the operation pattern. When the processing of step 112 is completed, the processing proceeds to step 114.

In step 114, the drive process is executed in the drive processing unit 106. Here, the opening and closing device 8 is driven in accordance with the decided operation pattern, and the window is operated to the fully closed state. When the processing of step 114 is completed, the processing proceeds to step 116. In step 116, it is confirmed that the door of the autonomous driving vehicle is closed. When the processing of step 116 is completed, the present routine is terminated.

As described above, with the vehicle control device 100 of the present embodiment, since the operation pattern is determined based on the opening degree of the window, it is possible to reflect different risks for each opening degree of the window in the operation pattern. As a result, the autonomous driving vehicle can automatically and safely operate the window to the fully closed state before the autonomous driving vehicle starts traveling by autonomous driving.

### Second Example

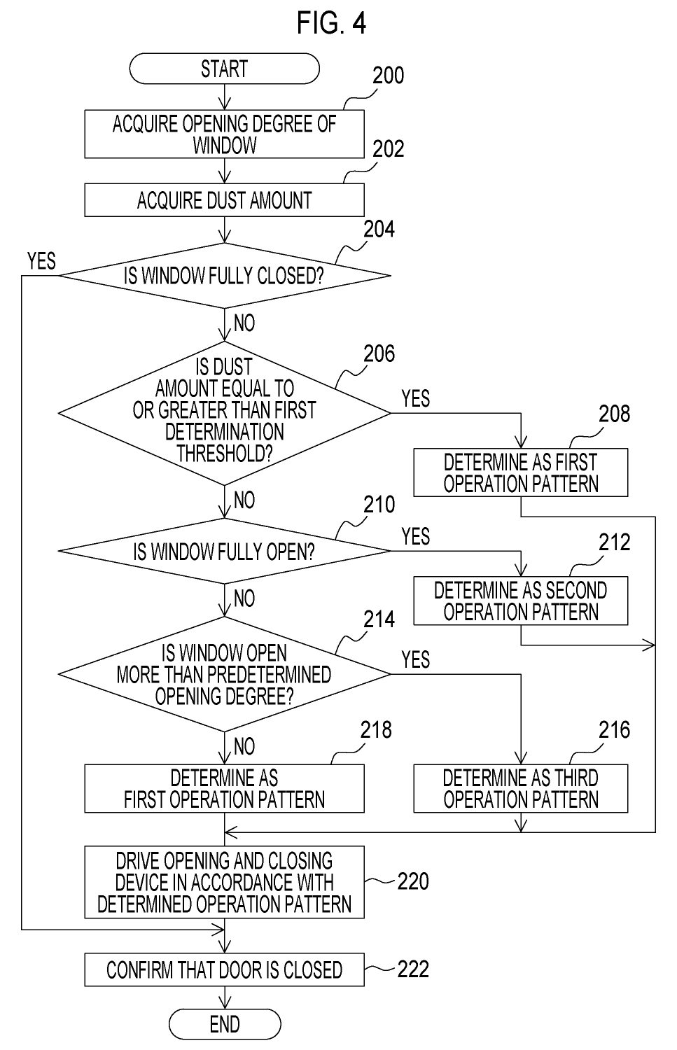

A second example of specific processing executed by the vehicle control device 100 of the present embodiment will be described. Depending on the amount of dust around the autonomous driving vehicle, a situation in which it is preferable to quickly fully close the window is also considered. The second example is an example of processing of further determining an operation pattern based on the amount of dust floating in the surrounding environment of the autonomous driving vehicle in addition to the opening degree of the window. FIG. 4 is a flowchart of a routine showing a second example of the processing executed by the vehicle control device of the present embodiment. The routine shown in FIG. 4 is executed by the control device 10 before the autonomous driving vehicle starts traveling by autonomous driving.

In step 200, the opening and closing state acquisition process is executed in the opening and closing state acquisition processing unit 102 to acquire the opening degree of the window. When the processing of step 200 is completed, the processing proceeds to step 202.

In step 202, the dust state acquisition process is executed in the dust state acquisition processing unit 108 to acquire the dust amount. When the processing of step 202 is completed, the processing proceeds to step 204.

The processing of steps 204 to 218 is a part of the operation pattern determination process executed by the operation pattern determination processing unit 104. In step 204, the determination is made whether the window is fully closed based on the opening degree of the window acquired by the opening and closing state acquisition process. As a result, in a case where the determination is established, the window closing operation is determined to be unnecessary, and the processing proceeds to step 222. On the other hand, in a case where the determination in step 204 is not established, the processing proceeds to step 206.

In step 206, determination is made whether the dust amount acquired by the dust state acquisition process is equal to or greater than a predetermined first determination threshold. The first determination threshold here is a value determined in advance as a limit amount of the dust amount allowed in the vehicle cabin. The first determination threshold is stored in the data 34 of the memory 30. Here, the first determination threshold is read from the memory 30 and is compared with the dust amount acquired by the dust state acquisition process. As a result, in a case where the determination is established, it is determined that the situation in which the dust amount equal to or greater than the limit amount enters from the open window is present, and the processing proceeds to step 208. In step 208, the first operation pattern is decided as the operation pattern. When the processing of step 208 is completed, the processing proceeds to step 220.

On the other hand, in a case where the determination in step 206 is not established, it is determined that the dust amount equal to or greater than the limit amount does not enter from the open window, and the processing proceeds to step 210. The processing from step 210 to step 222 is the same processing as the processing from step 104 to step 116 of the routine shown in FIG. 3.

As described above, with the vehicle control device 100 of the present embodiment, since the operation pattern is determined by considering both the opening degree of the window and the dust amount, the window can be automatically and safely closed while the damage to the vehicle cabin due to the surrounding dust is suppressed.

### Third Example

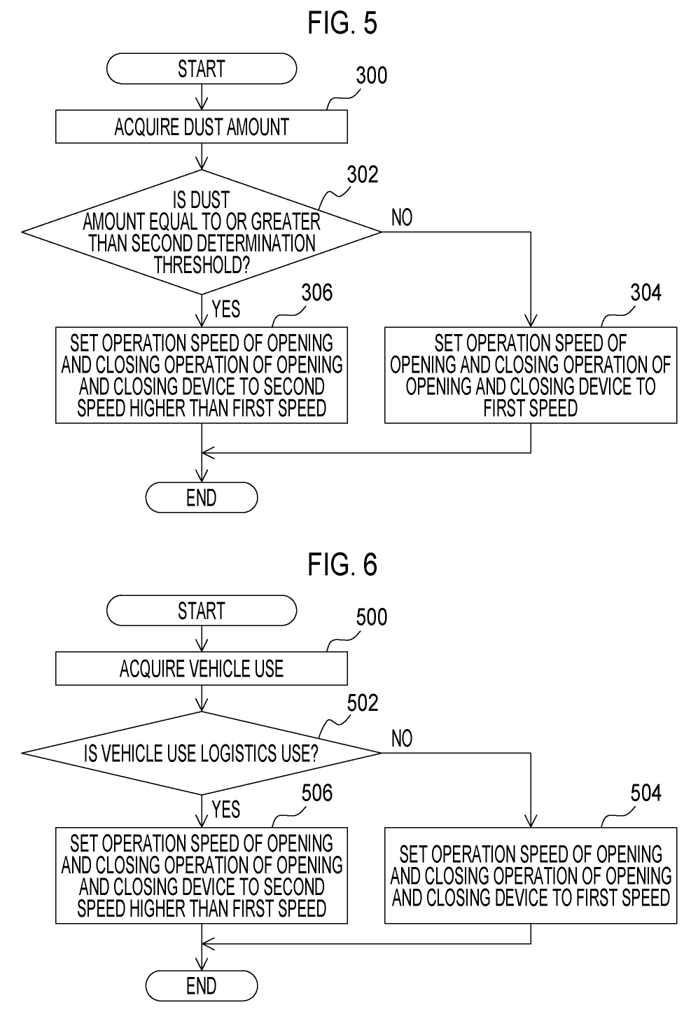

A third example of specific processing executed by the vehicle control device 100 of the present embodiment will be described. The third example is characterized by a configuration in which the operation speed of the opening and closing operation of the window in each of the operation patterns is set based on the amount of dust floating in the surrounding environment of the autonomous driving vehicle. FIG. 5 is a flowchart of a routine showing a third example of the processing executed by the vehicle control device of the present embodiment. The routine shown in FIG. 5 is executed by the control device 10 before the autonomous driving vehicle starts traveling by autonomous driving.

In step 300, the dust state acquisition process is executed in the dust state acquisition processing unit 108 to acquire the dust amount. When the processing of step 300 is completed, the processing proceeds to step 302.

The processing of steps 302 to 306 is a part of the operation pattern determination process executed by the operation pattern determination processing unit 104. In step 302, determination is made whether the dust amount acquired by the dust state acquisition process is equal to or greater than a predetermined second determination threshold. The second determination threshold here is, for example, a value determined in advance as a limit amount of a dust amount allowed in a vehicle cabin. The second determination threshold may be the same value as the first determination threshold or may be a different value. The threshold is stored in the data 34 of the memory 30. Here, the threshold is read from the memory 30 and is compared with the dust amount acquired by the dust state acquisition process. As a result, in a case where the determination is not established, it is determined that the dust amount equal to or greater than the limit amount does not enter from the open window, and the processing proceeds to step 304. In step 304, the operation speed of the opening and closing operation of the opening and closing device 8 based on the decided operation pattern is set to the first speed.

On the other hand, in a case where the determination in the processing of step 302 is established, it is determined that the dust amount equal to or greater than the limit amount enters from the open window, and the processing proceeds to step 306. In step 306, the operation speed of the opening and closing operation of the opening and closing device 8 based on the decided operation pattern is set to a second speed higher than the first speed. When the processing of step 304 or 306 is performed, the processing of the present routine is terminated.

As described above, with the vehicle control device 100 of the present embodiment, since the operation speed of the opening and closing device 8 is set according to the dust amount, the window can be quickly automatically closed while the damage to the vehicle cabin due to the surrounding dust is suppressed.

### Fourth Example

A fourth example of specific processing executed by the vehicle control device 100 of the present embodiment will be described. The risk of the opening and closing operation of the window being automatically performed is different depending on the use of the vehicle. For example, in a case where the vehicle use is the people flow use, the risk of the occurrence of the event in which the person is pinched in the window is higher than in a case where the vehicle use is the logistics use. Therefore, the fourth example is an example of processing of further determining the operation pattern based on the vehicle use of the autonomous driving vehicle in addition to the opening degree of the window.

In the processing according to the fourth example, in the control routine shown in FIG. 4, the vehicle use acquisition process is executed in the vehicle use acquisition

processing unit 110 instead of the processing of step 202, and the vehicle use is acquired. Then, instead of the processing of step 206, determination is made whether the vehicle use acquired by the vehicle use acquisition process is the logistics use. As a result, in a case where the determination is established, it is determined that the risk of the occurrence of the event in which the person is pinched in the window is low, and the processing proceeds to step 208. On the other hand, in a case where the determination is not established, the vehicle use is the people flow use, and it is determined that the risk of the occurrence of the event in which the person is pinched in the window is high, and the processing proceeds to step 210.

As described above, with the processing of the fourth example of the vehicle control device 100, since the operation pattern is determined according to the vehicle use as well as the opening degree of the window, the window can be quickly automatically closed while the risk of the occurrence of the event in which the person is pinched is suppressed.

With the processing of the fourth example of the vehicle control device 100, the following vehicle control device is realized.

In the vehicle control device of the present disclosure, the control device is further configured to execute a vehicle use acquisition process of acquiring vehicle use indicating whether the use of the autonomous driving started in the autonomous driving vehicle is a people flow use or a logistics use before the autonomous driving vehicle starts traveling by autonomous driving. In the operation pattern determination process, the control device is configured to determine a pattern of operating the window to a fully closed state without operating the window in an opening direction when the vehicle use is the logistics use.

### Fifth Example

A fifth example of specific processing executed by the vehicle control device 100 of the present embodiment will be described. The fifth example is characterized by a configuration in which the operation speed of the opening and closing operation of the window in each of the operation patterns is changed based on the vehicle use of the autonomous driving vehicle. FIG. 6 is a flowchart of a routine showing the fifth example of the processing executed by the vehicle control device of the present embodiment. The routine shown in FIG. 6 is executed by the control device 10 before the autonomous driving vehicle starts traveling by autonomous driving.

In step 500, the vehicle use acquisition process is executed in the vehicle use acquisition processing unit 110 to acquire the vehicle use. When the processing of step 500 is completed, the processing proceeds to step 502.

The processing of steps 502 to 506 is a part of the operation pattern determination process executed by the operation pattern determination processing unit 104. In step 502, determination is made whether the vehicle use acquired by the vehicle use acquisition process is the logistics use. As a result, in a case where the determination is not established, the vehicle use is the people flow use, and it is determined that the risk of the occurrence of the event in which the person is pinched in the window is high, and the processing proceeds to step 504. In step 504, the operation speed of the opening and closing operation of the opening and closing device 8 in the operation pattern is set to the first speed.

On the other hand, in a case where the determination in the processing of step 502 is established, it is determined that the risk of the occurrence of the event in which the person is pinched in the window is low, and the processing proceeds to step 506. In step 506, the operation speed of the opening and closing operation of the opening and closing device 8 in the operation pattern is set to a second speed higher than the first speed. When the processing of step 504 or 506 is performed, the processing of the present routine is terminated.

As described above, with the fifth example of the vehicle control device 100 of the present embodiment, since the operation speed of the opening and closing device 8 is set according to the vehicle use, the window can be quickly automatically closed while the risk of the occurrence of the event in which the person is pinched is suppressed.

With the processing of the fifth example of the vehicle control device 100, the following vehicle control device is realized.

In the operation pattern determination process of the vehicle control device of the present disclosure, the control device is configured to increase the operation speed of the opening and closing operation in the operation pattern when the vehicle use is the logistics use as compared with when the vehicle use is the people flow use.

What is claimed is:

1. A vehicle control apparatus configured to automatically perform an opening and closing operation of a window of an autonomous driving vehicle, the vehicle control apparatus comprising:
a window state detection device configured to detect an opening and closing state of the window;
an opening and closing device configured to open and close the window by driving an actuator; and
a control device configured to control an operation of the opening and closing device,
wherein, before the autonomous driving vehicle starts traveling by autonomous driving, the control device is configured to execute:
an opening and closing state acquisition process of acquiring the opening and closing state detected by the window state detection device;
an operation pattern determination process of determining an operation pattern of the opening and closing operation based on the acquired opening and closing state in the opening and closing state acquisition process; and
a drive process of driving the opening and closing device in accordance with the determined operation pattern in the operation pattern determination process.

2. The vehicle control apparatus according to claim 1, further comprising a dust detection device configured to detect a dust amount floating around the autonomous driving vehicle,
wherein, before the autonomous driving vehicle starts traveling by autonomous driving, the control device is configured to further execute a dust state acquisition process of acquiring the dust amount detected by the dust detection device, and
in the operation pattern determination process, the control device is configured to determine the operation pattern based on the acquired opening and closing state in the opening and closing state acquisition process and the acquired dust amount in the dust state acquisition process.

3. The vehicle control apparatus according to claim 1, wherein, in the operation pattern determination process, the control device is configured to determine, as the operation pattern:
a pattern in which, in a case where the acquired opening and closing state in the opening and closing state acquisition process is fully open, the window is operated to be closed by a predetermined amount, operated to be fully open again, and then operated to be fully closed;
a pattern in which, in a case where the acquired opening and closing state in the opening and closing state acquisition process indicates an opening degree between an intermediate opening degree that is predetermined and a fully closed opening degree, the window is operated to be fully closed without being operated in an opening direction; and
a pattern in which, in a case where the acquired opening and closing state in the opening and closing state acquisition process indicates an opening degree between the intermediate opening degree and the fully open opening degree, the window is operated to be fully open and then operated to be fully closed.

4. The vehicle control apparatus according to claim 2, wherein, in the operation pattern determination process, the control device is configured to determine, as the operation pattern, a pattern in which the window is fully closed without being operated toward an opening direction, in a case where the acquired dust amount in the dust state acquisition process is higher than a first determination threshold that is predetermined.

5. The vehicle control apparatus according to claim 2, wherein, in the operation pattern determination process, the control device is configured to set an operation speed of the opening and closing operation in the operation pattern to be higher in a case where the acquired dust amount in the dust state acquisition process is higher than a second determination threshold that is predetermined, as compared with a case where the dust amount is lower than the second determination threshold.
